(19) United States
(12) Patent Application Publication
(10) Pub. No.: US 2024/0193099 A1
(43) Pub. Date: Jun. 13, 2024

(54) STRUCTURE AND METHOD FOR DIGITAL DATA MEMORY CARD ENCRYPTION

(71) Applicant: Hui Lin, New Taipei City (TW)

(72) Inventor: Hui Lin, New Taipei City (TW)

(21) Appl. No.: 18/444,757

(22) Filed: Feb. 18, 2024

Related U.S. Application Data
(63) Continuation of application No. 17/773,014, filed on Apr. 28, 2022.

(51) Int. Cl. G06F 12/14; G06F 3/06; H04L 9/08; H04L 9/30

(52) U.S. Cl. CPC G06F 12/1408; G06F 3/0622; G06F 3/0644; G06F 3/0655; G06F 3/0679; H04L 9/088; H04L 9/30; G06F 2212/1052; G06F 2212/2022

(57) ABSTRACT

The present invention relates to a structure and a method for digital data memory card encryption. In a main body, a memory is provided in a memory card, and the memory itself is provided with a read controller that cooperates with a reader and a protection area, and is further divided into a hard disk partition table area and a file area. A portable storage identification (PSID) is written into any of the above-mentioned areas by using an application programming interface (API). Moreover, before the writing of the portable storage identification (PSID) by the application programming interface (API), a key instruction produced by means of an encryption and decryption logic is provided to the read controller by the application programming interface (API). The read controller first decrypts the key instruction, and transmits the result to the application programming interface (API) to further improve the security.

The invention is a Continuation Application (CA) of the U.S. patent application Ser. No. 17/773,014 filed at Apr. 28, 2022, invented and assigned to the inventor of the present invention, and thus the contents of the U.S. patent application Ser. No. 17/773,014 is incorporated into the present invention.

### TECHNICAL FIELD

The present invention relates to a structure and a method for digital data memory card encryption, in particular to a Digital Rights Management (DRM) for loading digital data that can only be accessed by obtaining rights into a memory card and encrypting it.

### BACKGROUND

Since the improvement of the computer and digital technologies, the content of many creations and works (such as movie or music content) are converted into digital audio-visual compressed files. Subsequently, the files may be burned, or recorded, to portable data storage media such as CDs or DVDs, or other audio/video (A/V) carriers for playing back. Other than movies and music, the contents may include speech contents, teaching contents, opera contents, etc. All these contents may be converted into digital A/V compression files (hereinafter referred to as digital data).

However, due to the progress of compression and duplication technologies, all contents can be easily converted into file formats which can be easily copied by various duplication or burning technologies. With the prevalence of networks, digital contents can be widely distributed by being uploaded to networks and downloaded from networks. As the intellectual assets of creators of such contents cannot be well protected due to new duplication technologies, the will for creativity may be suppressed. Therefore, there is an eager demand for a novel technology to prevent the digital contents from being copied when copying is not permitted, so as to protect the intellectual assets of musicians, publishers, actors, and the like, and to match the requirement of intellectual property laws.

In general, currently most portable data storage media for carrying digital data are in the forms of discs such as CDs and DVDs. Other than some less commonly used erasable optical discs which can be burnt many times, most carriers cannot be burnt repeatedly. Since these portable data storage media have large volumes, in many currently available players (such as MP3), the digital data are copied to memory cards (for example, SD cards) for use.

Current memory cards are mainly used to store the digital data and thus have the same use as discs. If a memory card can be used as a digital data carriers having the security features of secured digital (SD) card and small form factor, then it makes a preferable digital data carrier and can be carried easily and widely used with security function for the protection of the data recorded therein. Other than high transmission speed and large capacity, the SD memory cards currently available are relatively inexpensive to be accepted by the market. Thus, the time of memory cards as the choice for digital data carriers has come.

Typically, digital rights management (DRM) in a personal computer (PC), for example, can provide security in data transfer for downloading digital data through a network as the user pays a fee for downloading the digital data without fear of the downloaded data being copied or spread illegally. DRM can also be used to confine the times, identifies, time periods and the number of copies for duplication of the download contents. Nevertheless, current DRM techniques cannot provide data security for the data recorded on portable data storage media (especially in the case of memory cards).

In view of this, the inventor once invented and filed a Taiwanese patent application for “Structure and method for encrypting digital data memory card”, and obtained patent under No. I507993. Although the anticipated effect could be achieved, many years passed, the cracks are more innovative. The inventor believes that more rigorous steps should be taken for the encryption and decryption of the memory card itself.

### SUMMARY

In view of the lack of sufficient encryption and protection for memory cards in the prior art, consequently the intellectual property rights and privacy of various digital data that can only be accessed by obtaining rights cannot be fully protected. Therefore, the present invention specifically proposes a structure and a method for memory card encryption for the prior art, and the technical means for solving the prior problem. The present invention relates to a structure and a method for digital data memory card encryption. The memory itself in a memory card is provided with a read controller and a protection area, and is further divided into a hard disk partition table area and a file area. A portable storage identification (PSID) is written into any of the above-mentioned areas by using an application programming interface (API). When the file area in the memory card has recorded a right object (i.e. the digital data that needs to have the right to obtain), and other readers want to read the memory card, the portable storage identification (PSID) can be used as an encryption mechanism for identification and reading, so as to increase the security in the digital rights management (DRM) of the digital data on the memory card. Moreover, before the writing of the portable storage identification (PSID) by the application programming interface (API), a key instruction produced by means of an encryption and decryption logic is provided to the read controller by the application programming interface (API). The read controller first decrypts the key instruction, and transmits the result to the application programming interface (API).

Therefore, there are four areas in the memory card, including the controller area, the protection area, the partition table area, and the file area. The portable storage identification (PSID) may be recorded in the memory card by one of the following ways.
1. If the portable storage identification (PSID) is to be recorded into the read controller in the memory of the memory card, a general memory card reader such as a SD Card Reader, with an application programming interface (API) developed for the read controller in the memory of the memory card may be used. This is a safer way.
2. If the portable storage identification (PSID) is to be recorded into the protection area in the memory of the memory card, a special tool may be used for partitioning the protection area in the memory of the memory card. A general SD Card Reader with an application programming interface (API) developed for the protection area in the memory of the memory card may be used.
3. If the portable storage identification (PSID) is to be recorded into the hard disk partition table area in the memory of the memory card, the user may use the Windows™ operating system of Microsoft Corporation or other OS operating system to format the partition table area.
4. If the portable storage identification (PSID) is to be recorded into the file area in the memory of the memory card, the user may use the Windows™ operating system of Microsoft Corporation or other OS operating system to format the file area.

Moreover, before the writing of the portable storage identification (PSID) by the application programming interface (API), a key instruction produced by means of an encryption and decryption logic is provided to the read controller by the application programming interface (API). The read controller first decrypts the key instruction, and transmits the result to the application programming interface (API). In this way, the difficulty of interception and cracking by hackers and the crypto agility increase, there is no need to be afraid of interception and cracking by hackers.

### BRIEF DESCRIPTION OF THE DRAWINGS

FIG. 1 illustrates a schematic diagram of the structure of the memory card of the present invention.

FIG. 2 illustrates an operation flow diagram of the present invention.

FIG. 3 illustrates a schematic diagram of data pre-encryption and pre-decryption between the read controller and the application program interface of the present invention.

### DETAILED DESCRIPTION

In order that those skilled in the art can further understand the present invention, a detailed description is provided herewith. However, the description and the appended drawings are not to be used to confine the scope and spirit of the present invention defined in the appended claims.

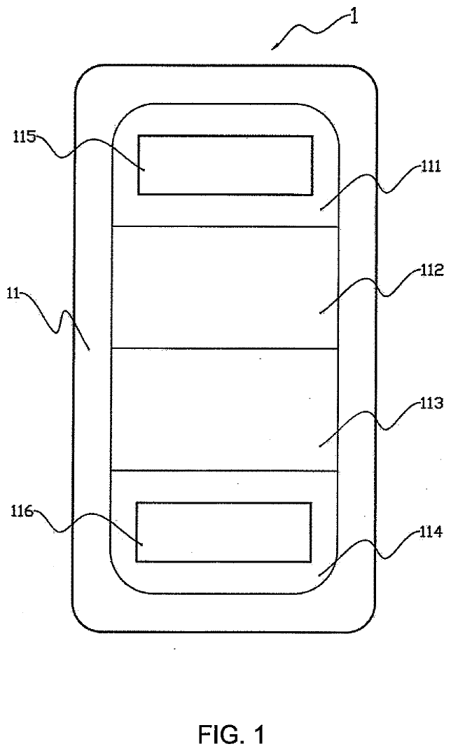

FIG. 1 shows a structure for digital data memory card encryption, which includes:

A memory card 1 and it contains a memory 11 therein. The memory 11 is provided with a read controller 111 that cooperates with a reader, and a protection area 112, and is further divided into a hard disk partition table area 113 and a file area 114. A portable storage identification (PSID) 115 is written into any of the above-mentioned areas by using an application programming interface (API) 118. When the file area 114 in the memory card 1 has recorded a right object 116 (i.e. the digital data that needs to have the right to obtain), and other readers want to read the memory card, the portable storage identification (PSID) 115 can be used as an encryption mechanism for identification and reading, so as to increase the security in the digital rights management (DRM) of the digital data on the memory card.

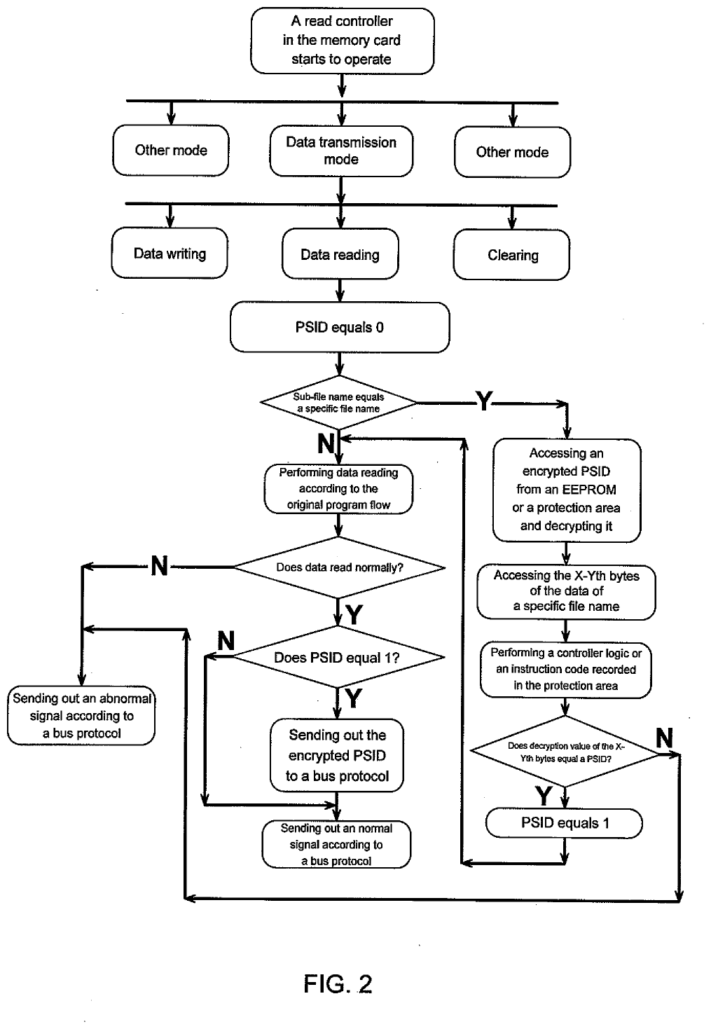

Referring to FIG. 2, a manufacturer of the read controller 111 of the memory card 1 must keep the application programming interface (API) 118 strictly confidential, or an unauthorized party could otherwise obtain the portable storage identification (PSID) 115 recorded in the memory 11 by using the application programming interface (API) 118, for example, the program recorded in the protection area 112 and the portable storage identification (PSID) 115.

In one embodiment, to further ensure the security of the PSID 115 in the memory card 1, the memory card 1 is formed as a personal storage disc. Additionally, a universal serial bus (USB) adaptor may be integrated with the memory card 1 so that the user can transfer data through the USB interface of a computing device. This makes it impossible for an unauthorized party to access or decode the data recorded in the memory 11 by detaching the memory card 1.

The memory 11 may be a flash memory in one embodiment, or an electrically-erasable programmable read-only memory (EEPROM) in an alternative embodiment.

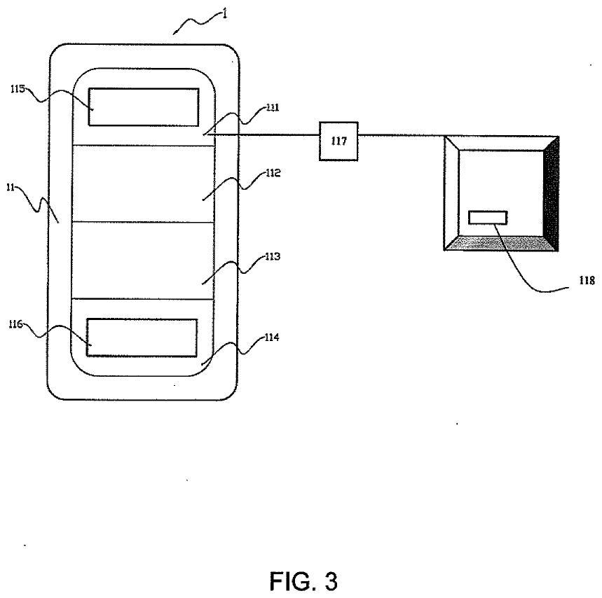

The portable storage identification (PSID) 115 may be recorded in one of the four areas of the memory card 1, as described below.
1. In one embodiment, if the portable storage identification (PSID) 115 is to be recorded into the read controller 111 in the memory 11 of the memory card 1, a general memory card reader such as a SD Card Reader, with an application programming interface (API) developed for the read controller in the memory of the memory card may be used for reading and writing data. This is a safer way. Referring to FIG. 3, the encryption/decryption logic between the read controller 111 and the application programming interface (API) 118 is that the public key infrastructure (PKI) 117 serving as the encryption/decryption logic between the encryption system server and the decryption program. The public key infrastructure (PKI) 117 is currently the most efficient encryption/decryption logic known in the art.
2. In another embodiment, if the portable storage identification (PSID) 115 is to be recorded into the protection area 112 in the memory 11 of the memory card 1, a special tool may be used for partitioning the protection area 112 in the memory 11 of the memory card 1. A general SD Card Reader with an application programming interface (API) developed for the protection area in the memory of the memory card may be used for reading and writing data.
3. In still another embodiment, if the portable storage identification (PSID) 115 is to be recorded into the hard disk partition table area 113, the user may use the Windows™ operating system of Microsoft Corporation or other OS operating system to format the partition table area 113.
4. In yet another embodiment, if the portable storage identification (PSID) 115 is to be recorded into the file area 114, the user may use the Windows™ operating system of Microsoft Corporation or other OS operating system to format the file area 114.

In one embodiment, regardless of which area the portable storage identification (PSID) 115 is recorded into, the rights object 116 needs to obtain rights to access the digital data. When various devices such as personal computers (PCs), mobile phones or various playback devices (collectively referred to as readers) want to read the files of the corresponding rights object 116, the read controller 111 decrypts the files of the rights object 116 by using controller logic in the read controller 111 or a program in the protection area 112, and obtains the corresponding portable storage identification (PSID) 115 from the decrypted file of the rights object 116 to compare with the portable storage identification (PSID) 115 recorded in the protection area 112. If the portable storage identification (PSID) recorded in the rights object 116 and the portable storage identification (PSID) 115 recorded in the memory 11 are matched, the file of the rights object 116 is provided to the playback device. If they are not matched, the playback device is informed that the reading operation is not permissible.

In one embodiment, only one portable storage identification (PSID) 115 is recorded in the read controller 111 or the protection area 112, no matter what technique (such as a read-only unique device ID or a random number generator with a one-time programming) is used to generate the portable storage identification (PSID) 115, the portable storage identification (PSID) 115 cannot be duplicated. The read controller 111 or the decrypting application programming interface (API) 118 of a playback device will compare the ID recorded in the rights object 116 with the portable storage identification (PSID) 115. When the portable storage identification (PSID) 115 recorded in the rights object 116 is matched to the portable storage identification (PSID) 115 recorded in the memory card, the decryption and playing operations can be performed.

Before the writing of the portable storage identification (PSID) 115 by the application programming interface (API) 118, a key instruction produced by means of an encryption and decryption logic is provided to the read controller 111 by the application programming interface (API) 118. The read controller 111 first decrypts the key instruction, and transmits the result to the application programming interface (API) 118. The data between the read controller 111 in the memory card 1 and the decryption application programming interface (API) 118 of the playback device is encrypted data (that is, the application programming interface (API) 118 wants to read or write to the protection area 112), the application programming interface (API) 118 needs to encrypt the command with the key obtained by agreement between the application programming interface (API) 118 and the read controller 111, and then send it to the read controller 111, and the read controller 111 first decrypts the command, decipher the command, execute the command, and then encrypts the command with the key obtained by agreement between the application programming interface (API) 118 and the read controller 111, and then send the result (command response or data) to the application programming interface (API) 118, and the application programming interface (API) 118 uses the key decryption result (command response or data) obtained by agreement between the application programming interface (API) and the read controller 111. In this way, the difficulty of interception and cracking by hackers and the crypto agility increase, there is no need to be afraid of interception and cracking by hackers.

Only the corresponding read controller 111 in the memory card and the decryption application programming interface (API) 118 of the playback device (as shown in the third figure) can perform the decryption, so as to prevent others from using the memory card reader (SD Card Reader) interface to intercept data.

FIG. 2 will be further described herein. In one embodiment, when the read controller 111 accepts instructions from a data retrieval device for reading data, it will identify the name of a sub-file, such as a portion or a component of the memory 11 (read-only memory, or ROM, for example). When it is confirmed that the sub-file name is a specific file name formed from one or more variables recorded in the protection area 112, the portable storage identification (PSID) 115 encrypted and recorded in the protection area 112 (may be an EEPROM or flash memory, for example) is decrypted. One or more bits of data of the sub-file name is compared with the portable storage identification (PSID) 115 according to the controller logic in the controller area 111 or an instruction code recorded in the protection area 112. If the bit or bits of data from the sub-file name matches the portable storage identification (PSID) 115, the data retrieval device can read data in the memory card. If there is no match, however, an abnormal signal is sent out according to a bus protocol.

The present invention provides a digital data protection mechanism. Other than music and image, even video and other digital data, can be protected effectively to assure only the authorized digital data can be used. An illegal invader cannot access the data.

The present invention is thus described. Many variations thereof are not to be regarded as a departure from the spirit and scope of the present disclosure, and all such modifications as would be obvious to one skilled in the art are intended to be included within the scope of the following claims.

What is claimed is:

1. A method for digital data memory card encryption, wherein a memory is provided in a memory card. The memory itself is provided with a read controller that cooperates with a reader, and a protection area, and is further divided into a hard disk partition table area and a file area. A portable storage identification (PSID) is written into any of the above-mentioned areas by using an application programming interface (API). When the file area in the memory card has recorded a right object, and other readers want to read the memory card, the portable storage identification (PSID) can be used as an encryption mechanism for identification and reading, so as to increase the security in the digital rights management (DRM) of the digital data on the memory card. Moreover, before the writing of the portable storage identification (PSID) by the application programming interface (API), a key instruction produced by means of an encryption and decryption logic is provided to the read controller by the application programming interface (API). The read controller first decrypts the key instruction, and transmits the result to the application programming interface (API).

2. The method for digital data memory card encryption as described in claim 1, wherein the memory is a kind of flash memory (FLASH), electrically erasable programmable read-only memory (EEPROM).

3. The method for digital data memory card encryption as described in claim 1, wherein the application programming interface (API) uses a read controller to be placed in the protection zone of the memory.

4. The method for digital data memory card encryption as described in claim 1, wherein the application programming interface (API) uses Microsoft Windows operating systems (Windows) to be placed in the hard disk partition table area.

5. The method for digital data memory card encryption as described in claim 1, wherein the application programming interface (API) uses Microsoft Windows operating systems (Windows) to be placed in the file area of the memory.

6. The method for digital data memory card encryption as described in claim 1, wherein the memory card is an integrated personal storage disc (PSD).

7. A structure for digital data memory card encryption, wherein the memory card includes a memory, and the memory is provided with:
a read controller,
a protection area,
a hard disk partition table area, and a file area.
A portable storage identification (PSID) is written into any of the above-mentioned areas by using an application programming interface (API). Moreover, before the writing of the portable storage identification (PSID) by the application programming interface (API), a key instruction produced by means of an encryption and decryption logic is provided to the read controller by the application programming interface (API). The read controller first decrypts the key instruction, and transmits the result to the application programming interface (API).

8. The structure for digital data memory card encryption as described in claim 7, wherein the memory is a kind of flash memory (FLASH), electrically erasable programmable read-only memory (EEPROM).

9. The structure for digital data memory card encryption as described in claim 7, wherein the memory card is an integrated personal storage disc (PSD).

10. The structure for digital data memory card encryption as described in claim 7, wherein the encryption/decryption logic between the read controller of the memory card and the application programming interface (API) is that the public key infrastructure (PKI) serving as the encryption/decryption logic between the encryption system server and the decryption program.
